(19) United States
(12) Patent Application Publication
(10) Pub. No.: US 2016/0352661 A1
(43) Pub. Date: Dec. 1, 2016

(54) VIDEO COMMUNICATION METHOD AND APPARATUS

(71) Applicant: Xiaomi Inc., Beijing (CN)

(72) Inventors: Wankun Yang, Beijing (CN); Kun Niu, Beijing (CN); Yifan Zhu, Beijing (CN)

(21) Appl. No.: 15/164,896

(22) Filed: May 26, 2016

(30) Foreign Application Priority Data
May 29, 2015 (CN) 201510290039.6

(51) Int. Cl. H04L 12/58; H04L 29/08; H04N 7/15; H04L 29/06

(52) U.S. Cl. CPC H04L 51/046; H04L 65/403; H04L 67/104; H04N 7/15; H04L 67/10

(57) ABSTRACT

A video communication method and apparatus are provided. The method includes: determining whether or not to switch a video image for a video communication with a peer device of the terminal device and the terminal device when the video communication is in progress; switching the video image for the video communication from a first video image acquired by the terminal device to a second video image acquired by a designated smart device when it is determined to switch the video image for the video communication, the designated smart device being communicatively coupled to the terminal device; and sending the second video image to the peer device. Accordingly, video images acquired by the designated smart device may be flexibly switched at the terminal device side, and thus video images at the terminal device side can be displayed at a peer device of the terminal device flexibly.

### CROSS-REFERENCE TO RELATED APPLICATIONS

This application is based upon and claims priority to Chinese Patent Application No. 201510290039.6, filed May 29, 2015, the entire contents of which are incorporated herein by reference.

### TECHNICAL FIELD

The present disclosure generally relates to technical field of Internet, and more particularly, to a video communication method and apparatus.

### BACKGROUND

With the rapid development of communication technology, text input is not required for video communications, and people can communicate with each other face-to-face via voice and/or video. Thus, more and more users prefer to use the video communication. In the related art, when a user A logs in a chat software (or an application) using a chat account in a mobile phone terminal and performs video communication with a user B, if the user A desires to log in the chat software using the same chat account in a computer terminal at the same time, a video source of the mobile phone terminal is switched to another video source of the computer terminal. In this case, the user B can only view video images from the video source of the computer terminal.

### SUMMARY

The present disclosure provides a video communication method and apparatus for improving flexibility of presenting different video sources.

According to a first aspect of embodiments of the present disclosure, there is provided a video communication method, implemented by a terminal device, including: determining whether or not to switch a video image for a video communication with a peer device of the terminal device and the terminal device when the video communication is in progress; switching the video image for the video communication from a first video image acquired by the terminal device to a second video image acquired by a designated smart device when it is determined to switch the video image for the video communication, the designated smart device being communicatively coupled to the terminal device; and sending the second video image to the peer device.

According to a second aspect of embodiments of the present disclosure, there is provided a video communication apparatus, including: a processor; and a memory for storing instructions executable by the processor. The processor is configured to: determine whether or not to switch a video image for a video communication between a peer device of the terminal device and the terminal device when the video communication is in progress; switch the video image for the video communication from a first video image acquired by the terminal device to a second video image acquired by a designated smart device when it is determined to switch the video image for the video communication, the designated smart device being communicatively coupled to the terminal device; and send the second video image to the peer device.

According to a third aspect of the embodiments of the present disclosure, there is provided a non-transitory computer-readable storage medium including instructions, executable by a processor in a video communication apparatus, for performing a video communication method, the method including: determining whether or not to switch a video image for a video communication between a peer device of the terminal device and the terminal device when the video communication is in progress; switching the video image for the video communication from a first video image acquired by the terminal device to a second video image acquired by a designated smart device when it is determined to switch the video image for the video communication, the designated smart device being communicatively coupled to the terminal device; and sending the second video image to the peer device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a flow chart of a video communication method, according to an exemplary embodiment.

FIG. 1B is a scenario where a video communication method may be applied, according to an exemplary embodiment.

FIG. 2 is a flow chart of a video communication method, according to an exemplary first embodiment.

FIG. 3 is a flow chart of a video communication method, according to an exemplary second embodiment.

FIG. 4 is a block diagram of a video communication apparatus, according to an exemplary embodiment.

FIG. 5 is a block diagram of another video communication apparatus, according to an exemplary embodiment.

FIG. 6 is a block diagram applicable for a video communication apparatus, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

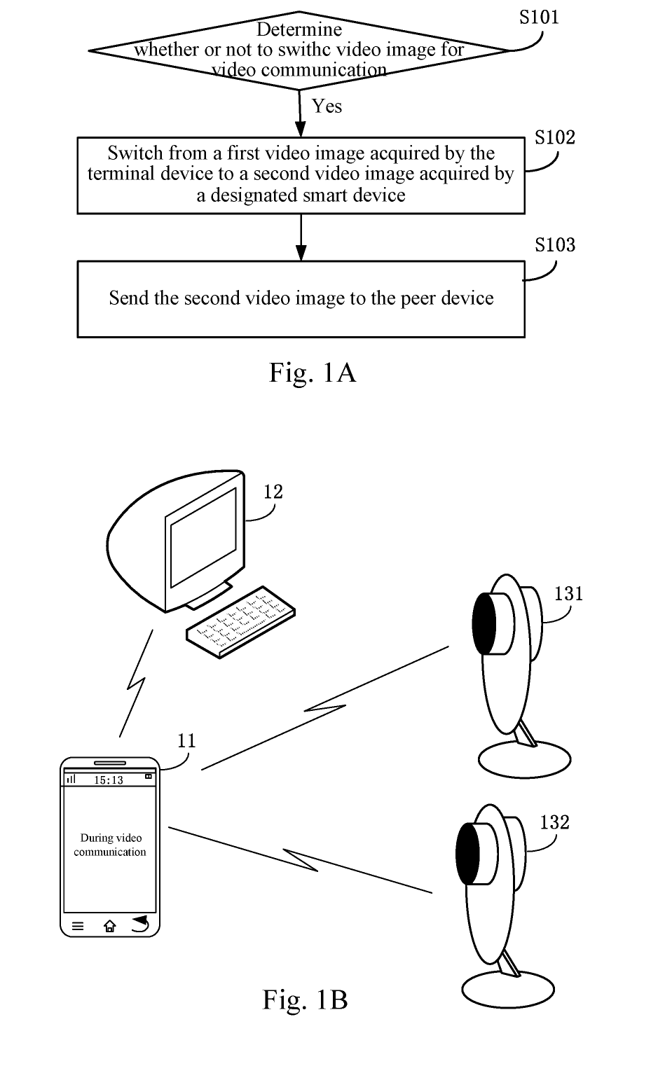

FIG. 1A is a flow chart of a video communication method, according to an exemplary embodiment. FIG. 1B is a scenario where the video communication method can be used, according to an exemplary embodiment. The video communication method may be implemented by a terminal device such as a smart phone, a tablet computer, or a desktop computer. As shown in FIG. 1A, the video communication method includes the following steps S101-S103.

In step S101, when a video communication between the terminal device and a peer device of the terminal device is in progress, whether or not to switch a video image for the video communication is determined.

In an embodiment, the terminal device may conduct the video communication with the peer device via Internet, or may conduct the video communication with the peer device via a mobile communication network such as a 3G or 4G communication network. In an embodiment, the video image for the video communication may be switched by a first instruction message received from the peer device, wherein the first instruction message may be provided by a user of the peer device according to his/her requirement. In another embodiment, the video image may be switched by a second instruction message in the terminal device, wherein the second instruction message may be generated by a user of the terminal device operating the terminal device according to an instruction provided by the user of the peer device.

In step S102, when it is determined to switch the video image, the video image for the video communication is switched from a first video image acquired by the terminal device to a second video image acquired by a designated smart device. The designated smart device is communicatively coupled to the terminal device.

In an embodiment, the designated smart device may be designated by the peer device, or may be designated by the terminal device, particularly, may be determined by the user of the terminal device or the user of the peer device according to specific requirements. In an embodiment, the number of the smart device communicatively coupled with the terminal device via a local area network may be one, or may be two or more. In an embodiment, different smart devices may be provided at different locations, thereby video images in different directions or spaces may be acquired, and the terminal device may record respective identities of the smart devices and their positions in a list.

In step S103, the second video image is sent to the peer device.

In an embodiment, the network used for sending the second video image to the peer device can be determined according to a type of the network for the video communication between the terminal device and the peer device. For example, when the video communication can be conducted between the terminal device and the peer device only via the 3G or 4G communication network, in order to ensure normal communication therebetween, the second video image may be sent to the peer device via the 3G or 4G communication network. Moreover, when the video communication may be conducted between the terminal device and the peer device via Internet, the second video image may be sent to the peer device via Internet. In this way, the cost of network communication for the terminal device is reduced.

Hereinafter, illustration to the present disclosure is given with reference to FIG. 1B. As shown in FIG. 1B, when it is detected that a smart phone 11 has accessed to Internet, and a video communication is in progress between a user using the smart phone 11 and a user using a desktop computer 12, the smart phone 11 may first detect a type of the communication connection with a smart camera 131 and a smart camera 132. If the smart phone 11 detects that the smart phone 11 is connected with the smart camera 131 and the smart camera 132 via a local area network, when the smart phone 11 needs to switch a video image for the video communication with the desktop computer from a first video image to a second video image acquired by either of the smart camera 131 and the smart camera 132, the smart phone 11 may acquire the second video image from the smart camera 131, and then send the second video image to the desktop computer 12 via Internet or a 3G or 4G communication network. In this case, the smart camera 131 and the smart camera 132 do not need to access to Internet or the 3G or 4G communication network, and video images acquired by different smart devices may be flexibly switched in the smart phone 11.

In another embodiment, if the smart phone 11 detects that the smart mobile phone 11 is not connected with the smart camera 131 via the local area network, the smart phone 11 may determine a type of a communication connection which may be established with the smart camera 131. For example, if the smart phone 11 detects that the communication connection with the smart camera 131 may be established via the 4G communication network, then the smart phone 11 may receive the video image from the smart camera 131 via the 4G communication network, thereby ensuring that the user of the peer device can view the video image acquired by the smart camera 131. Similarly, if the smart phone 11 detects that the communication connection with the smart camera 131 may be established via Internet, then the smart phone 11 may receive the video image from the smart camera 131 via Internet, thereby ensuring that the user of the peer device can view the video image acquired by the smart camera 131. Still similarly, if the smart phone 11 detects that the communication connection with the smart camera 131 may be established via the 3G communication network, then the smart phone 11 may receive the video image from the smart camera 131 via the 3G communication network, thereby ensuring that the user of the peer device can view the video image acquired by the smart camera 131.

In the present embodiment, when it is determined to switch the video image, the video image for the video communication is switched from the first video image acquired by the terminal device to the second video image acquired by the designated smart device. In this way, the video image acquired by the designated smart device may be flexibly switched at the terminal device side, and the video images of the terminal device side displayed by the peer device may be flexible as well, which facilitates the user of the peer device to view the video images acquired by different smart devices at the terminal device side, and improves the flexibility of presenting different video sources.

In an embodiment, determining whether or not to switch the video image for the video communication may include: detecting whether a first instruction message from the peer device is received; and when the first instruction message is received, determining whether or not to switch the video image for the video communication according to the first instruction message.

In an embodiment, determining whether or not to switch the video image for the video communication according to the first instruction message may include: detecting a first operation triggered by the first instruction message; and when the first operation triggered by the first instruction message is detected, determining to switch the video image for the video communication.

In an embodiment, determining whether or not to switch the video image for the video communication may include:detecting whether a second instruction message from the terminal device is received; and when the second instruction message is received, determining whether or not to switch the video image for the video communication according to the second instruction message.

In an embodiment, switching the video image for the video communication from the first video image acquired by the terminal device to the second video image acquired by the designated smart device may include: determining an identity of the designated smart device; connecting the designated smart device with the terminal device communicatively via a local area network according to an identity of the designated smart device; and switching the video image for the video communication from the first video image acquired by the terminal device to the second video image acquired by the designated smart device according to the identity of the designated smart device.

In an embodiment, sending the second video image to the peer device may include: detecting a type of network for the video communication with the peer device; when it is detected that the communication with the peer device is via a mobile communication network, sending the second video image to the peer device via the mobile communication network; and when it is detected that the communication with the peer device is via Internet, sending the second video image to the peer device via Internet.

The specific implementation of the video communication will be elaborated below with reference to the following embodiments.

For the above methods provided by the embodiments of the present disclosure, the video images acquired by the designated smart devices at the terminal device side can be flexibly switched, such that the video images of the terminal device side displayed at the peer device are flexible as well. It is convenient for the user of the peer device to view the video images acquired by different smart devices at the terminal device side, and the flexibility of presenting different video sources is improved.

Hereinafter, the technical solutions provided by the embodiments of the present disclosure are described with reference to specific embodiments.

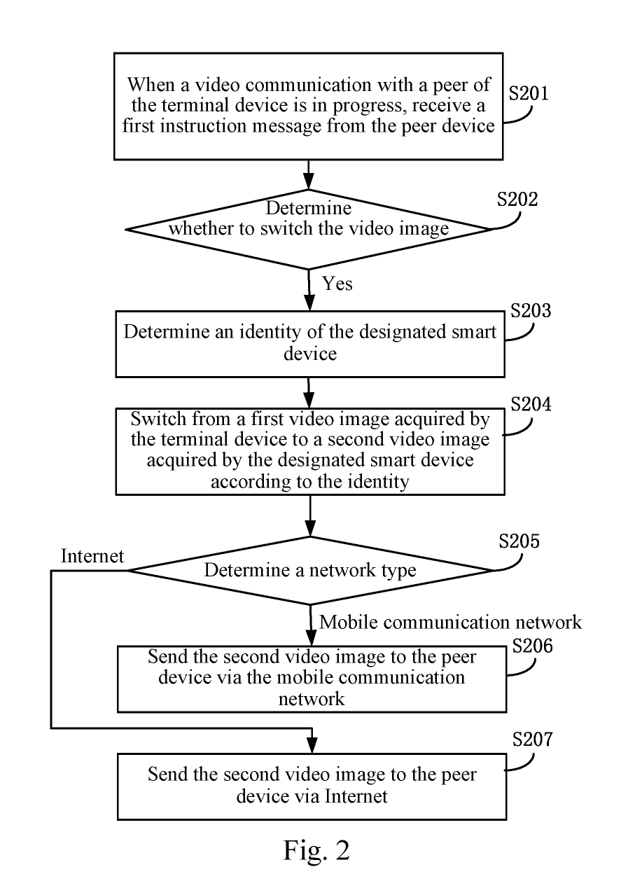

FIG. 2 is a flow chart of a video communication method, according to an exemplary first embodiment. The present embodiment is illustrated by utilizing the above methods provided in the embodiments of the present disclosure with reference to the system shown in FIG. 2. In the example, the terminal device receives a first instruction message from the peer device to implement the video communication. As shown in FIG. 2, the method includes the following steps.

In step S201, when a video communication between a terminal device and a peer device of the terminal device is in progress, a first instruction message from the peer device is received.

In an embodiment, the first instruction message from the peer device may be generated by clicking on a relevant key on a video communication software or a video communication application (app) in the peer device by a user, and the terminal device may receive the first instruction message via Internet, or may receive the first instruction message via a 3G or 4G communication network.

In step S202, it is determined whether or not to switch a video image for the video communication according to the first instruction message.

In an embodiment, it is possible to determine that the video image needs to be switched when a first operation triggered by the first instruction message is detected, wherein the first operation may be an operation of confirmation to the first instruction message. For example, in an embodiment, when the first instruction message sent from the peer device is received, a control key of confirmation to the first instruction message will be included in the first instruction message, and then the user of the terminal device may click on the confirmation control key to confirm that the video image needs to be switched. For another example, the first instruction message may also include a control key for rejecting the first instruction message, and the user of the terminal device may click on the rejection control key to confirm that the video image does not need to be switched.

In step S203, when it is determined that the video image needs to be switched, an identity of the designated smart device is determined.

In step S202 and step S203, it is possible to analyze the first instruction message so as to determine whether the first instruction message includes a first request message for switching the video image for the video communication. If the first request message for switching video image is included, it is determined that the video image needs to be switched, and then the identity of the smart device designated by the user of the peer device may be obtained by analyzing the first instruction message.

In step S204, the video image for the video communication is switched from the first video image acquired by the terminal device to the second video image acquired by the designated smart device according to the identity.

For example, as shown in FIG. 1B, the peer device is a desktop computer 12, the desktop computer 12 adds the identity of the smart camera 131 into the first instruction message. Therefore, when the first instruction message is received by the smart phone 11, it may analyze the first instruction message and then determine that the smart device whose video image will be switched to is the smart camera 131.

In step S205, a type of network for the video communication with the peer device is determined. If the video communication with the peer device is via a mobile communication network, then step S206 is performed. If the video communication with the peer device is via Internet, then step S207 is performed.

In an embodiment, the terminal device may not only conduct video communication with the peer device via the mobile communication network, but also may conduct the video communication via Internet. In an embodiment, the mobile communication network may be a network such as a 3G or 4G communication network provided by a network operator.

In step S206, when it is detected that the video communication with the peer device is via a mobile communication network, the second video image is sent to the peer device via the mobile communication network.

In step S207, when it is detected that the video communication with the peer device is via Internet, the second video image is sent to the peer device via Internet.

In an embodiment, when the terminal device side does not access to Internet via a WIFI network, in order to ensure that the user of the peer device can view the scene pictures at the terminal device side and the smart device side, the terminal device may send the second video image to the peer device via the 3G or 4G communication network. When the terminal device side can access to Internet via the WIFI network or a wired network, in order to save the communication cost for the user of the terminal device, the terminal device may send the second video image to the peer device via Internet.

As an illustrative scenario, as shown in FIG. 1B, the user of the smart phone 11 is at home, and the smart camera 131 and the smart camera 132 are respectively disposed at different rooms of the house of the user of the smart phone 11. A user of a desktop computer 12 may conduct a video communication with the user of the smart phone 11, in order to check respective conditions of the spaces corresponding to the smart camera 131 and the smart camera 132. In this case, the user of the desktop computer 12 may send a first instruction message to the smart phone 11, and the first instruction message carries information indicative of the space of which smart camera is needed to be checked (such as the smart camera 131). After analyzing the first instruction message, if it is detected that a first operation is triggered by the first instruction message, the smart phone 11 may determine that the video image for the video communication needs to be switched, then the smart phone 11 may switch the video image for the video communication from a first video image acquired by the camera device of the smart phone 11 to a second video image acquired by the smart camera 131, thereby the user of the desktop computer 12 can view the image acquired by the smart camera 131.

In addition to the advantageous technical effects of the above embodiments, the present embodiment may switch the first video image currently acquired by the terminal device to the second video image of the smart device designated by the first instruction message using the first instruction message of the peer device, which facilitates the control to the terminal device side by the peer device, and improves autonomy of switching the video scenes of the terminal device side by the user of the peer device.

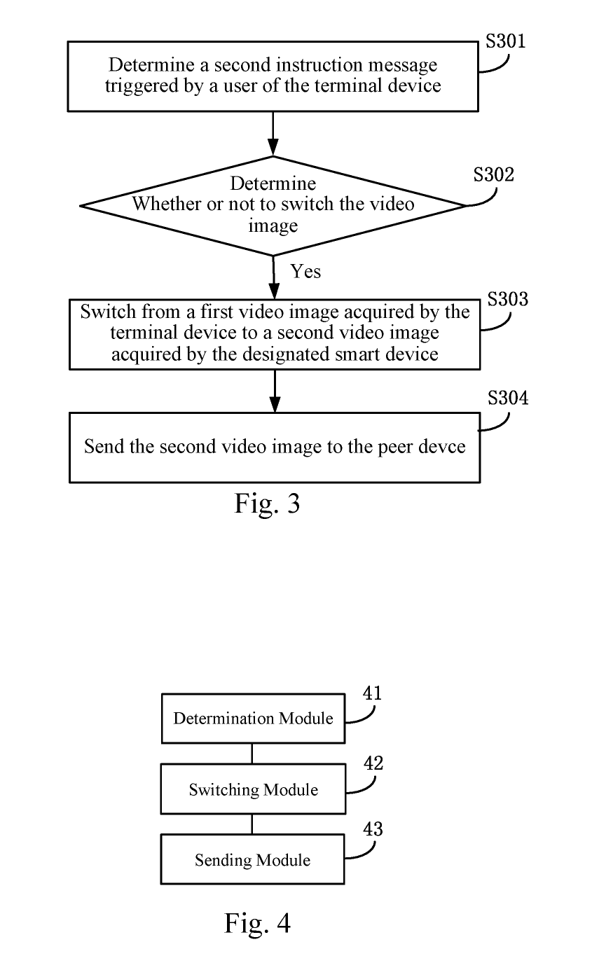

FIG. 3 is a flow chart of a video communication method, according to an exemplary second embodiment. The present embodiment is illustrated by utilizing the above methods provided in the embodiments of the present disclosure with reference to the system shown in FIG. 1B. In the example, the terminal device side determines a second instruction message to implement the video communication. As shown in FIG. 3, the method includes the following steps.

In step S301, when a video communication between a terminal device and a peer device of the terminal device is in progress, a second instruction message triggered by a user of the terminal device is determined.

In an embodiment, the second instruction message may be generated by clicking on a relevant key on a video communication software or a video communication application (app) provided in the terminal device by a user of the terminal device.

In step S302, whether or not to switch the video image for the video communication is determined according to the second instruction message.

In an embodiment, it is possible to analyze the second instruction message so as to determine whether the second instruction message carries a second request message for switching the video image for the video communication. If the second request message for switching the video image is carried with the message, it is determined that the video image needs to be switched, and then an identity of the smart device designated by the terminal device may be obtained by analyzing the second instruction message.

In step S303, when it is determined that the video image for the voice communication needs to be switched, the video image for the voice communication is switched from a first video image acquired by the terminal device to a second video image acquired by the designated smart device.

The specific description of step S303 may be referred to the above step S102, or the above step S203 to step S204, which is not elaborated herein.

In step S304, the second video image is sent to the peer device.

The specific description of step S304 may be referred to the above step S103, or the above step S205 to step S207, which is not elaborated herein.

As an illustrative scenario, as shown in FIG. 1B, it is assumed that the terminal mobile phone is the smart phone 11, the user of the smart phone 11 is at home, and the smart camera 131 and the smart camera 132 are respectively disposed at different rooms of the house of the user of the smart phone 11. When a user of a desktop computer 12 conducts a video communication with the user of the smart phone 11, if the user of the smart phone 11 does not allow the user of the desktop computer 12 to view the first video image acquired by the camera device of the smart phone 11, a second instruction message may be generated by clicking on a relevant key on the smart phone 11, then the smart phone 11 may analyze the second instruction message, and switches the video image for the video communication from the first video image to the second video image designated by the smart phone 11.

In addition to the advantageous technical effects of the above embodiments, the present embodiment switches the first video image currently acquired by the terminal device to the second video image of the smart device designated by the second instruction message using the second instruction message of the terminal device. In this way, when it is inconvenient for the user of the terminal device to allow the user of the peer device to view the scene image acquired by the terminal device, the video image for the video communication can be switched to the second video image, thereby improving the autonomy of switching the video scenes by the user of the terminal device.

FIG. 4 is a block diagram of a video communication device, according to an exemplary embodiment. The video communication device is implemented by a terminal device. As shown in FIG. 4, the video communication device includes: a determination module 41, a switching module 42, and a sending module 43.

The determination module 41 is configured to, when a video communication between a terminal device and a peer device of the terminal device is in progress, determine whether or not to switch a video image for the video communication.

The switching module 42 is configured to, when the determination module 41 determines to switch the video image, switch the video image for the video communication from a first video image acquired by the terminal device to a second video image acquired by a designated smart device. The designated smart device is communicatively coupled to the terminal device.

The sending module 43 is configured to send the second video image switched by the switching module 42 to the peer device.

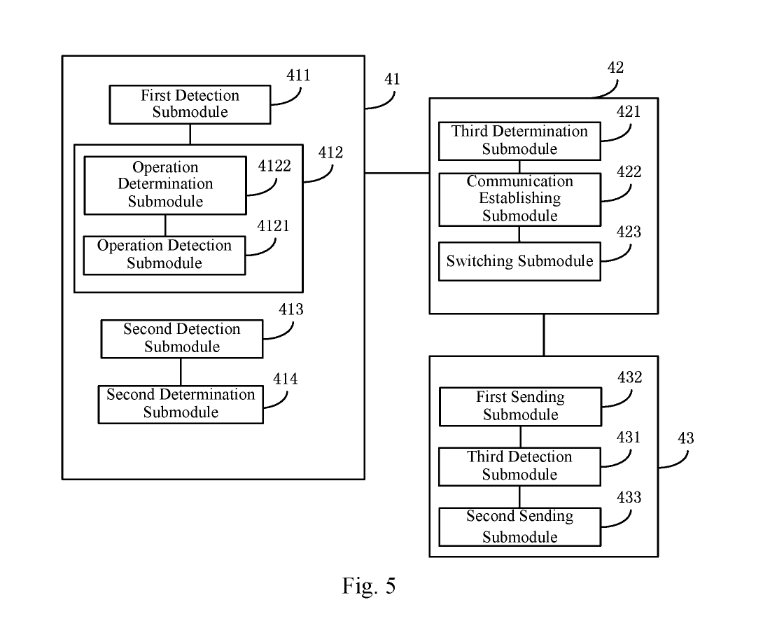

FIG. 5 is a block diagram of another video communication device, according to an exemplary embodiment. On basis of the above embodiment shown in the FIG. 4, in an embodiment, the above determination module 41 may include: a first detection submodule 411 and a first determining submodule 412.

The first detection submodule 411 is configured to detect whether a first instruction message from the peer device is received.

The first determining submodule 412 is configured to, when the first detection submodule 411 receives the first instruction message, determine whether or not to switch the video image for the video communication according to the first instruction message.

In an embodiment, the first determining submodule 412 may include: an operation detection submodule 4121 and an operation determination submodule 4122.

The operation detection submodule 4121 is configured to detect whether a first operation triggered by the first instruction message is received.

The operation determination submodule 4122 is configured to, when the first operation triggered by the first instruction message is detected, determine to switch the video image for the video communication.

For example, the first operation is an operation of confirmation to the first instruction message. For example, in an embodiment, when a first instruction message sent from the peer device is received, a control key for confirmation to the first message information is included with the message, then the user of the terminal device may click on the confirmation control key so as to confirm that the video image needs to be switched. In addition, the first instruction message may also carry a control key for rejecting the first instruction message, and the user of the terminal device may click on the rejection control key so as to confirm that the video image does not need to be switched.

In an embodiment, the above determination module 41 may include: a second detection submodule 413 and a second determination submodule 414.

The second detection submodule 413 is configured to detect whether a second instruction message from the terminal device is received.

The second determination submodule 41 is configured to, when the second detection submodule 413 detects that the second instruction message is received, determine whether or not switch the video image for the video communication according to the second instruction message.

In an embodiment, the switching module 42 may include: a third determination submodule 421, a communication establishing submodule 422, and a switching submodule 423.

The third determination submodule 421 is configured to determine an identity of the designated smart device.

The communication establishing submodule 422 is configured to determine that the designated smart device is communicatively connected to the terminal device via a local area network according to the identity determined by the third determination submodule 421.

The switching submodule 423 is configured to switch the video image for the video communication from the first video image acquired by the terminal device to the second video image acquired by the designated smart device via the communication connection established by the communication establishing submodule 422 according to the identity.

In an embodiment, the sending module 43 may include: a third detection submodule 431, a first sending submodule 432, and a second sending submodule 433.

The third detection submodule 431 is configured to detect a network type for the video communication with the peer device.

The first sending submodule 432 is configured to, when the third detection submodule 431 detects that the communication with the peer device is via a mobile communication network, send the second video image to the peer device via the mobile communication network; and

The second sending submodule 433 is configured to, when the third detection submodule 431 detects that the communication with the peer device is via Internet, send the second video image to the peer device via Internet.

With respect to the devices in the above embodiments, the specific manners for performing operations for individual modules therein have been described in detail in the embodiments regarding the methods, which will not be elaborated herein.

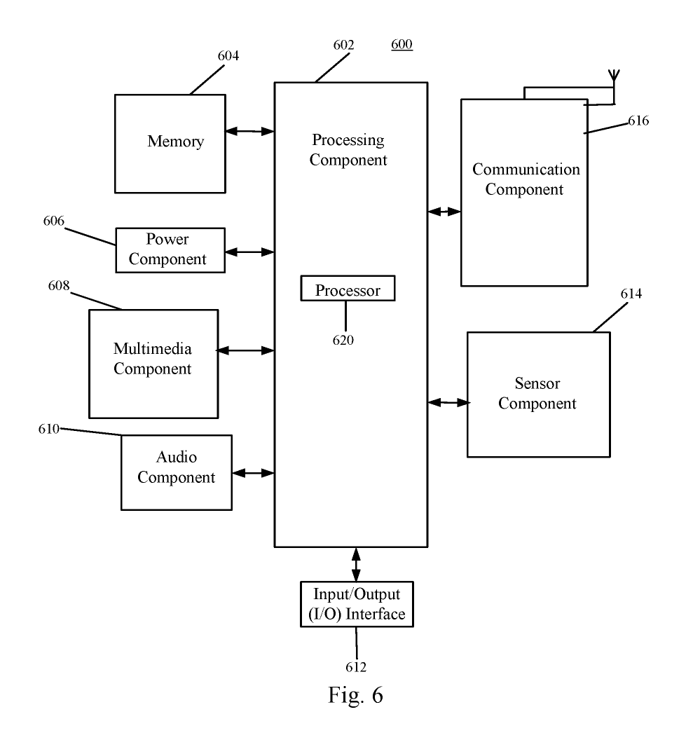

FIG. 6 is a block diagram applicable for a video communication device, according to an exemplary embodiment. For example, the device 600 may be a mobile phone, a computer, a digital broadcast terminal, a messaging device, a gaming console, a tablet, a medical device, exercise equipment, a personal digital assistant, and the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G, or 3G, or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A video communication method, implemented by a terminal device, comprising:
determining whether or not to switch a video image for a video communication between a peer device of the terminal device and the terminal device when the video communication is in progress;
switching the video image for the video communication from a first video image acquired by the terminal device to a second video image acquired by a designated smart device when it is determined to switch the video image for the video communication, the designated smart device being communicatively coupled to the terminal device; and
sending the second video image to the peer device.

2. The method of claim 1, wherein the determining whether or not to switch the video image for the video communication comprises:
when a first instruction message from the peer device is received, determining whether or not to switch the video image for the video communication according to the first instruction message.

3. The method of claim 2, wherein the determining whether or not to switch the video image for the video communication according to the first instruction message comprises:
determining to switch the video image for the video communication when a first operation triggered by the first instruction message is detected.

4. The method of claim 1, wherein the determining whether or not to switch the video image for the video communication comprises:
when a second instruction message from the terminal device is received, determining whether or not to switch the video image for the video communication according to the second instruction message.

5. The method of claim 1, wherein the switching the video image for the video communication from the first video image acquired by the terminal device to the second video image acquired by the designated smart device comprises:
connecting the designated smart device with the terminal device communicatively via a local area network according to an identity of the designated smart device; and
switching the video image for the video communication from the first video image acquired by the terminal device to the second video image acquired by the designated smart device according to the identity of the designated smart device.

6. The method of claim 1, wherein the sending the second video image to the peer device comprises:
when it is detected that the communication with the peer device is via a mobile communication network, sending the second video image to the peer device via the mobile communication network; and
when it is detected that the communication with the peer device is via Internet, sending the second video image to the peer device via Internet.

7. A video communication apparatus, comprising:
a processor; and
a memory for storing instructions executable by the processor;
wherein the processor is configured to:
determine whether or not to switch a video image for a video communication between a peer device of the terminal device and the terminal device when the video communication is in progress;
switch the video image for the video communication from a first video image acquired by the terminal device to a second video image acquired by a designated smart device when it is determined to switch the video image for the video communication, the designated smart device being communicatively coupled to the terminal device; and
send the second video image to the peer device.

8. The apparatus of claim 7, wherein the processor is further configured to:
when a first instruction message from the peer device is received, determine whether or not to switch the video image for the video communication according to the first instruction message.

9. The apparatus of claim 8, wherein the processor is further configured to:
determine to switch the video image for the video communication when a first operation triggered by the first instruction message is detected.

10. The apparatus of claim 7, wherein the processor is further configured to:
when a second instruction message from the terminal device is received, determine whether or not to switch the video image for the video communication according to the second instruction message.

11. The apparatus of claim 7, wherein the processor is further configured to:
connect the designated smart device with the terminal device communicatively via a local area network according to an identity of the designated smart device; and
switch the video image for the video communication from the first video image acquired by the terminal device to the second video image acquired by the designated smart device according to the identity of the designated smart device.

12. The apparatus of claim 7, wherein the processor is further configured to:
when it is detected that the communication with the peer device is via a mobile communication network, send the second video image to the peer device via the mobile communication network; and
when it is detected that the communication with the peer device is via Internet, send the second video image to the peer device via Internet.

13. A non-transitory readable storage medium comprising instructions, executable by a processor in a video communication apparatus, for performing a video communication method, the method comprising:
determining whether or not to switch a video image for a video communication between a peer device of the terminal device and the terminal device when the video communication is in progress;
switching the video image for the video communication from a first video image acquired by the terminal device to a second video image acquired by a designated smart device when it is determined to switch the video image for the video communication, the designated smart device being communicatively coupled to the terminal device; and
sending the second video image to the peer device.
